(19) United States
(12) Patent Application Publication
(10) Pub. No.: US 2010/0180426 A1
(43) Pub. Date: Jul. 22, 2010

(54) PARTICLE REDUCTION TREATMENT FOR GAS DELIVERY SYSTEM

(75) Inventors: DAVID DATONG HUO, Campbell, CA (US); Irene Ai-Lin Chou, San Jose, CA (US); David Koonce, San Mateo, CA (US); Jennifer Y. Sun, Mountain View, CA (US)

Correspondence Address: MOSER IP LAW GROUP / APPLIED MATERIALS, INC., 1030 BROAD STREET, 2ND FLOOR, SHREWSBURY, NJ, 07702, US

(73) Assignee: APPLIED MATERIALS, INC., Santa Clara, CA (US)

(21) Appl. No.: 12/356,687

(22) Filed: Jan. 21, 2009

(51) Int. Cl. B23P 17/00

(52) U.S. Cl. 29/527.1

(57) ABSTRACT

Methods and apparatus for reducing particles in a gas delivery system are provided herein. In some embodiments, a method of fabricating a gas distribution apparatus, such as a gas distribution plate or nozzle, for a semiconductor process chamber includes providing a gas distribution apparatus having one or more apertures adapted to flow a gas therethrough. A slurry is flowed through the one or more apertures to remove a damaged surface from sidewalls of the plurality of apertures. In some embodiments, the gas distribution apparatus may be oxidized before or after flowing the slurry through the one or more apertures. In some embodiments, the gas distribution apparatus may be conditioned by providing RF power to the gas distribution plate for a desired period of time.

### BACKGROUND

1. Field

Embodiments of the present invention generally relate to semiconductor process equipment.

2. Description of the Related Art

As the critical dimensions for semiconductor devices continues to shrink, there is an unyielding need to improve the cleanliness of the processing environment within a semiconductor process chamber. Such contamination may be caused, in part, by chamber components. For example, contamination may be caused by gas delivery components, such as a showerhead. Specifically, manufacturing methods, such as ultrasonic drilling to form apertures in the showerhead, can lead to particulates forming on the walls of the apertures. In some instances, the particulates can be at least partially removed, for example, by thermal oxidation processes and by radio frequency (RF) conditioning the showerhead after thermal oxidation. However, the showerhead often requires more than 100 hours of RF conditioning prior to using in a semiconductor process chamber in order to satisfactorily reduce particles.

Thus, there is a need in the art for improved methods of manufacturing components for semiconductor process chambers.

### SUMMARY

Methods and apparatus for reducing particles in a gas delivery system are provided herein. In some embodiments, a method of fabricating a gas distribution apparatus, such as a gas distribution plate or nozzle, for a semiconductor process chamber includes providing a gas distribution apparatus having a one or more apertures adapted to flow a gas therethrough. A slurry is flowed through the plurality of apertures to remove a damaged surface from sidewalls of the one or more apertures. In some embodiments, the gas distribution apparatus may be oxidized before or after flowing the slurry through the one or more apertures. In some embodiments, the gas distribution apparatus may be conditioned by providing RF power to the gas distribution plate for a desired period of time.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a process chamber having a gas distribution system in accordance with some embodiments of the present invention.

FIG. 2 depicts a flow chart of method for manufacturing a gas distribution plate in accordance with some embodiments of the present invention.

FIG. 3 depicts a schematic, partial top view of a gas distribution plate in accordance with some embodiments of the present invention.

FIGS. 4A-C respectively depict schematic side views, in cross section, of a gas distribution plate during fabrication in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Methods and apparatus for reducing particles in a gas delivery system are provided herein. In some embodiments, gas distribution apparatus, such as gas distribution plates or nozzles, for use in a gas delivery system, and methods of fabrication thereof, are provided herein. The inventive gas distribution apparatus advantageously provides low particle generation during processing. The inventive manufacturing methods may advantageously improve manufacturing time and improve a process environment within a semiconductor process chamber. The inventive method may advantageously reduce or eliminate the need for additional manufacturing steps, such as oxidation or radio frequency (RF) seasoning of the gas distribution plate. In some embodiments, RF seasoning may be eliminated or reduced to less than or equal to about 5 hours.

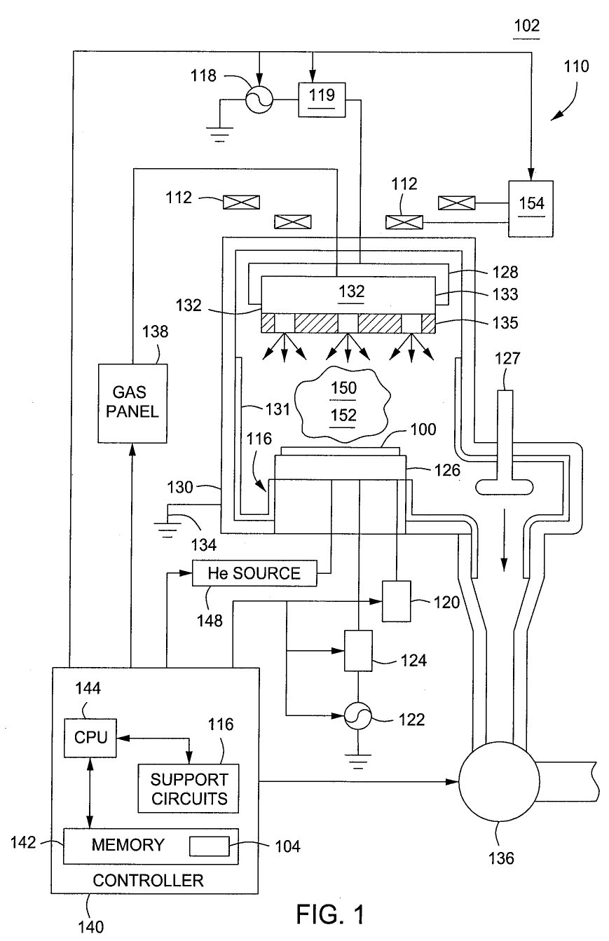

Gas delivery systems including a gas distribution plate or one or more nozzles according to embodiments of the present invention may be incorporated in any suitable semiconductor processing system. For example, FIG. 1 illustratively depicts a schematic diagram of an exemplary dual frequency capacitive plasma source reactor 102 incorporation a gas delivery system 104 in accordance with embodiments of the present invention. Such a reactor may, for example, be utilized to perform etch processes that may be used to form the dual damascene structures. The dual frequency capacitive plasma source reactor may be included in a processing system such as the CENTURA® semiconductor wafer processing system commercially available from Applied Materials, Inc. of Santa Clara, Calif. The reactor may be adapted for processing 300 mm wafers, operates in broad ranges of the process parameters and etchant chemistries, may use an endpoint detection system, and has in-situ self-cleaning capabilities. In one embodiment, the reactor uses a 160 MHz plasma source to produce a high density plasma, a 13.56 MHz wafer bias source and a plasma magnetizing solenoid, such that the reactor provides independent control of ion energy, plasma density and uniformity, and wafer temperature. A detailed description of a suitable dual frequency capacitive plasma source reactor is provided in U.S. patent application Ser. No. 10/192,271, filed Jul. 9, 2002 which is commonly assigned to Applied Materials, Inc., and is herein incorporated by reference in its entirety.

The dual frequency capacitive plasma source reactor 102 is exemplary, and the gas delivery system 104 as described herein may be disposed in any suitable process chamber, such as chambers configured for etch, chemical vapor deposition (CVD), plasma enhanced CVD (PECVD), physical vapor deposition (PVD), thermal processing, or any other suitable process that requires a gas distribution plate. Exemplary process chambers may include the DPS®, ENABLER®, ADVANTEDGE™, or other process chambers, available from Applied Materials, Inc. of Santa Clara, Calif. Other suitable chambers include any chambers that may have a need for reduced particulates from the gas distribution plate.

The reactor 102 comprises a process chamber 110 having a conductive chamber wall 130 that is connected to an electrical ground 134 and at least one solenoid segment 112 positioned exterior to the chamber wall 130. The chamber wall 130 comprises a ceramic liner 131 that facilitates cleaning of the chamber 110. The byproducts and residue of an etch process are readily removed from the liner 131 after each wafer is processed. The solenoid segment(s) 112 are controlled by a DC power source 154 that is capable of producing at least 5 V.

The gas delivery system 104 is coupled to the process chamber 110 to deliver process gases thereto, for example from a gas panel 138. As depicted in FIG. 1, the gas delivery system 104 illustratively includes a showerhead 132 having a processing plenum 133 and a gas distribution apparatus 116 for distributing process gases into the chamber process 110. In some embodiments, as depicted in FIG. 1, the gas distribution apparatus 116 may be a gas distribution plate 135. Alternatively or in combination, the gas distribution apparatus 116 may include one or more gas distribution nozzles (not shown) in place of, or in addition to, the gas distribution plate 135 (and/or the showerhead 132). The composition and fabrication techniques disclosed herein apply to all embodiments of gas distribution apparatus, such as the gas distribution plate 135, the nozzles, or the like.

The showerhead 132 (e.g., the processing plenum 133 and the gas distribution plate 135) may comprise dielectric or conducting materials. In some embodiments, the showerhead 132 may be a conducting material and perform the dual purpose of both delivering a process gas to the chamber and as an electrode for forming or maintaining a plasma (e.g., upper electrode 128 discussed below). The gas distribution apparatus 116 (e.g., the gas distribution plate 135 in the embodiment of FIG. 1) may comprise a dielectric or conducting material depending on the particular functions the showerhead 132 performs in the process chamber. In some embodiments, the gas distribution apparatus 116 (e.g., the gas distribution plate 135) comprises silicon and carbon, such as silicon carbide, or oxide ceramics, such as yttrium oxide.

Process chamber 110 also includes a substrate support 116 that is spaced apart from the showerhead 132. The substrate support 116 comprises an electrostatic chuck 126 for retaining a substrate 100 beneath the showerhead 132. The showerhead 132 may comprise a plurality of gas distribution zones such that various gases can be supplied to the chamber 110 using a specific gas distribution gradient. The showerhead 132 is mounted to (or forms at least part of) an upper electrode 128 that opposes the substrate support 116. The electrode 128 is coupled to an RF source 118.

The electrostatic chuck 126 is controlled by a DC power supply 120 and the substrate support 116, through a matching network 124, which is coupled to a bias source 122. Optionally, the source 122 may be a DC or pulsed DC source. The upper electrode 128 is coupled to a radio-frequency (RF) source 118 through an impedance transformer 119 (e.g., a quarter wavelength matching stub). The bias source 122 is generally capable of producing a RF signal having a tunable frequency of 50 kHz to 13.56 MHz and a power of between 0 and 5000 Watts. The source 118 is generally capable of producing a RF signal having a tunable frequency of about 160 MHz and a power between about 0 and 2000 Watts. The interior of the chamber 110 is a high vacuum vessel that is coupled through a throttle valve 127 to a vacuum pump 136. Those skilled in the art will understand that other forms of the plasma etch chamber may be used to practice the invention, including a reactive ion etch (RIE) chamber, an electron cyclotron resonance (ECR) chamber, and the like.

In operation, a substrate 100 is placed on the substrate support 116, the chamber interior is pumped down to a near vacuum environment, and a gas 150, which when ignited produces a plasma, is provided to the process chamber 110 from the gas panel 138 via the showerhead 132. The gas 150 is ignited into a plasma 152 in the process chamber 110 by applying the power from the RF source 118 to the upper electrode 128 (anode). A magnetic field may be applied to the plasma 152 via the solenoid segment(s) 112, and the substrate support 316 may be biased by applying the power from the bias source 122. During processing of the substrate 100, the pressure within the interior of the etch chamber 110 is controlled using the gas panel 138 and the throttle valve 127.

The temperature of the chamber wall 130 may be controlled using liquid-containing conduits (not shown) that are located in and around the wall. Further, the temperature of the substrate 100 may be controlled by regulating the temperature of the substrate support 116 via a cooling plate (not shown) having channels formed therein for circulating a coolant. Additionally, a back side gas (e.g., helium (He) gas) is provided from a gas source 148 into channels, which are formed by the back side of the substrate 100 and the grooves (not shown) in the surface of the electrostatic chuck 326. The helium gas is used to facilitate a heat transfer between the pedestal 116 and the substrate 100. The electrostatic chuck 126 is heated by a resistive heater (not shown) within the chuck body to a steady state temperature and the helium gas facilitates uniform heating of the substrate 100. Using thermal control of the chuck 126, the substrate 100 may be maintained at a temperature of between 10 and 500 degrees Celsius.

A controller 140 may be used to facilitate control of the chamber 110 as described above. The controller 140 may be one of any form of a general purpose computer processor used in an industrial setting for controlling various chambers and sub-processors. The controller 140 comprises a central processing unit (CPU) 144, a memory 142, and support circuits 146 for the CPU 144 and coupled to the various components of the etch process chamber 110 to facilitate control of the etch process. The memory 142 is coupled to the CPU 144. The memory 142, or computer-readable medium, may be one or more of readily available memory such as random access memory (RAM), read only memory (ROM), floppy disk, hard disk, or any other form of digital storage, local or remote. The support circuits 146 are coupled to the CPU 144 for supporting the processor in a conventional manner. These circuits include cache, power supplies, clock circuits, input/output circuitry and subsystems, and the like. A software routine 156, when executed by the CPU 144, causes the reactor to perform processes of the present invention and is generally stored in the memory 142. The software routine 156 may also be stored and/or executed by a second CPU (not shown) that is remotely located from the hardware being controlled by the CPU 344.

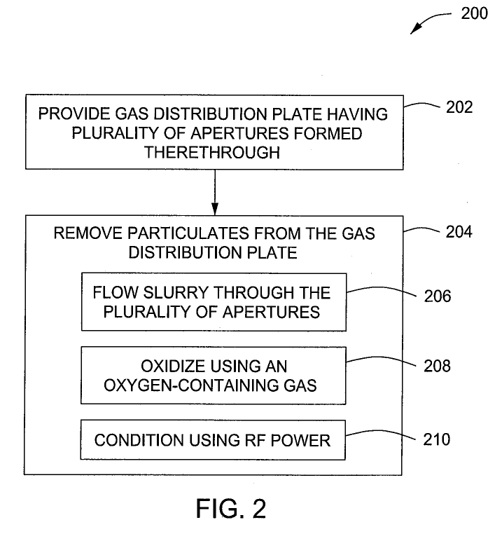

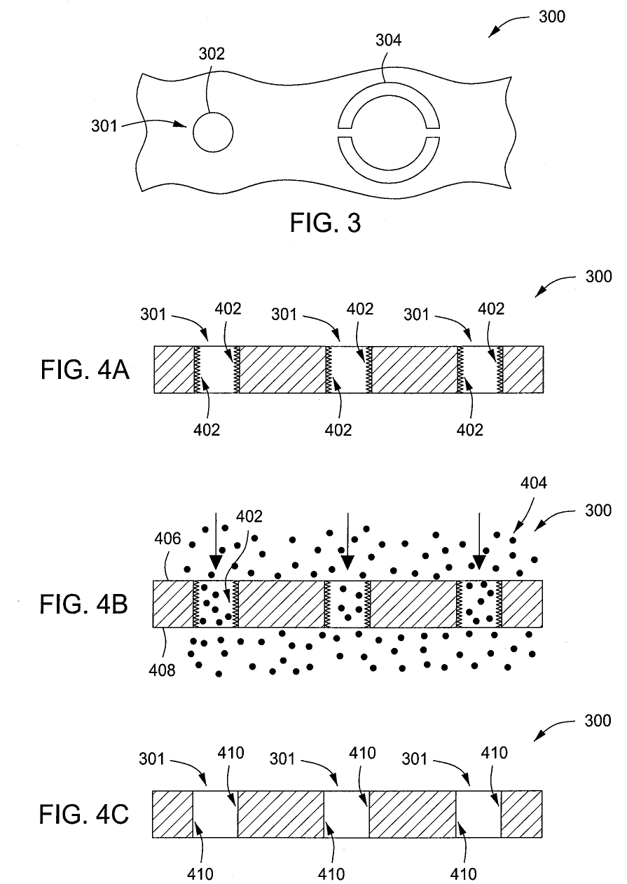

The gas distribution apparatus 116 (for example, the gas distribution plate 135 or gas distribution nozzles) may be fabricated using the methods described below. Embodiments of the inventive methods are provided in the flow chart depicted in FIG. 2, and described in accordance with the fabrication of a gas distribution plate 300 depicted in FIGS. 3 and 4A-C. Similar techniques may be utilized to fabricate gas distribution nozzles or other embodiments of the gas distribution apparatus 116.

The method 200 begins at 202 by providing a gas distribution plate having a plurality of apertures formed therethrough. A partial schematic top view of a gas distribution plate 300 is shown in FIG. 3A. The gas distribution plate 300 may be similar to the gas distribution plate 135 discussed above with respect to FIG. 1. The gas distribution plate 300 includes a plurality of apertures 301 formed therethrough. The apertures 301 may have any suitable shape, such as circular (302), c-slot (304), or the like. Other shapes of the apertures 301 may also be provided as desired. The gas distribution plate 300 may have any suitable dimensions for incorporation into a showerhead or other gas distribution system as desired. For example, in some embodiments, the gas distribution plate 300 may have a thickness of between about 2 to about 20 mm. The gas distribution plate 300 may also have a diameter of between about 350 to about 500 mm.

In some embodiments, the gas distribution plate 300 may comprise silicon and carbon (e.g., such as silicon carbide) or other ceramics, such as oxide ceramics, for example, yttrium oxide. The plurality of apertures 301 may be formed in any suitable fashion, such as by ultrasonic drill, electrical discharge machine (EDM), or the like. Although two apertures are illustrated in FIG. 3A for simplicity, the gas distribution plate 300 typically comprises a plurality of apertures 301 disposed in a desired geometry to facilitate delivery of one or more process gases to the process chamber during processing. The plurality of apertures 301 may include any one or more of the shapes discussed above (e.g., circular 302, c-slot 304, or the like).

As illustrated in a cross-sectional view in FIG. 4A, the formation of the apertures 302 and 304 typically results in particulates and/or defects (damaged surface 402 for simplicity) along the sidewalls of each aperture. The damaged surface 402 may be rough surfaces of the wall, particles attached to the wall, contaminants from the method of forming each aperture, or any such particulate matter or defect that may come loose and contaminate a substrate when the gas distribution plate (or nozzles) is utilized as part of a showerhead or other gas distribution system in a process chamber.

At 204, the damaged surface 402 may be removed from the gas distribution plate 300. In some embodiments, the damaged surface 402 may be removed by an extrusion honing process that includes flowing a slurry 404 through the plurality of apertures 301, as shown at 206 and illustrated in FIG. 4B. The slurry 404 may be flowed through the plurality of apertures 301 to remove the damaged surface 402. For example, the slurry 404 may be provided on a first side 406 of the gas distribution plate 300 and may be forced under pressure to flow through the plurality of apertures 301 to a second side 408 of the gas distribution plate 300. The particles in the slurry 404 remove the damaged surface 402 from the sidewalls of the apertures 301 when flowing therethrough, providing as smoother, honed surface. The slurry 404 may be repeatedly flowed back and forth through the apertures 301 until a desired finish is obtained (for example, using surface morphology micrographs as a guideline for the final target). In some embodiments, the slurry is flowed for a desired period of time. In some embodiments, the desired finish may have less than about 9 particulates at about 0.15 micrometer particle size for wafer particle performance

The slurry 404 may comprise particles disposed in a liquid. In some embodiments, the particles may comprise at least one of diamond, silicon carbide (SiC), or boron carbide (BC). The particles may have diameters ranging from between about 1 um to about 100 um. The particles may be delivered in a solution comprising water or any other liquid capable of suspending the particles, such as an oil-based plasticizer, for example, AFM Media available from Extrude Hone Corporation of Irwin, Pa. In some embodiments, the particles may comprise between about 10 to about 80 percent by weight of the solution. The viscosity of the slurry 404 may be adjusted by adjusting either particle concentration, solution composition, or a combination thereof. Increased viscosity may improve removal of the damaged surface 402. In some embodiments, the viscosity of the slurry 404 may be between about 150,000 centipoise (cP) to about 750,000 cP.

For example, the gas distribution plate 300 (or nozzles) may be placed in an apparatus (not shown) for forcing the slurry 400 through the plurality of apertures 301 from side to side of the gas distribution plate 300. For example, the apparatus may include a piston disposed on either side of the gas distribution plate 300. The slurry 404 may be forced through the plurality of apertures 301 by alternating the stroke of each piston. The force supplied by each piston, the frequency of the piston motion, and the residence time in the apparatus may be adjusted as desired to satisfactorily remove the damaged surface 402. In some embodiments, the slurry is flowed through the plurality of apertures for up to about 54 minutes, or about 30 minutes.

In some embodiments, after flowing the slurry 404 through the plurality of apertures 301, the method 200 may end and the gas distribution plate 300 (or nozzles) may be cleaned and installed in the gas distribution system. Alternatively, in some embodiments, the gas distribution plate 300 (or nozzles) may be oxidized by a thermal oxidation process at 208. However, the oxidation process need not be limited to thermal oxidation, and any suitable oxidation process may be used. Such an oxidation process may be performed in a process chamber capable of thermal oxidation, rapid thermal oxidation, or the like.

In some embodiments, after thermally oxidizing the gas distribution plate 300, the method 200 may end and the gas distribution plate 300 may be cleaned (if necessary) and installed in the gas distribution system. Alternatively, in some embodiments, the gas distribution plate 300 may be conditioned using RF power at 210.

The extrusion honing treatment of the gas distribution apparatus (e.g., the gas distribution plate 300 or nozzles) advantageously reduces or eliminates the quantity of damaged surface 402 from the gas distribution plate 300, resulting in a clean, smooth aperture wall 410, as illustrated in FIG. 4C. In some embodiments, the inventive methods may reduce the number of particulates to less than nine at 0.15 micrometers particulate size for on wafer performance. In some embodiments, the inventive methods disclosed herein may advantageously reduce the manufacturing time to produce a gas distribution apparatus (e.g., e.g., a gas distribution plate or nozzles).

Thus, gas distribution apparatus, such as gas distribution plates or nozzles, for use in gas delivery systems of semiconductor process chambers, and methods of fabrication thereof, have been provided herein. The inventive methods may advantageously facilitate improved processing of semiconductor wafer by the reduction of particulates resultant from fabrication of the gas distribution apparatus. The inventive methods may further advantageously reduce process steps and/or processing time for the fabrication of gas distribution apparatus suitable for use in a semiconductor process chamber.

While the foregoing is directed to embodiments of the present invention, other and further embodiments of the invention may be devised without departing from the basic scope thereof, and the scope thereof is determined by the claims that follow.

What is claimed is:

1. A method of fabricating a gas distribution apparatus for a semiconductor process chamber, comprising:
providing a gas distribution apparatus having one or more apertures adapted to flow a gas therethrough; and
flowing a slurry through the one or more apertures to remove a damaged surface from sidewalls of the plurality of apertures.

2. The method of claim 1, wherein the gas distribution apparatus is a gas distribution plate having the one or more apertures formed therethrough.

3. The method of claim 1, wherein the gas distribution apparatus comprises one or more nozzles.

4. The method of claim 1, wherein the gas distribution apparatus comprises silicon and carbon.

5. The method of claim 1, wherein the gas distribution apparatus comprises an oxide ceramic.

6. The method of claim 1, wherein the gas distribution apparatus comprises yttrium oxide.

7. The method of claim 1, wherein the slurry comprises at least one of diamond, silicon carbide, or boron carbide particles.

8. The method of claim 1, wherein the slurry includes particles in a solution comprising water or an oil-based plasticizer.

9. The method of claim 8, wherein the particles comprise between about 10 percent to about 80 percent by weight of the solution.

10. The method of claim 8, wherein a viscosity of the slurry is between about 150,000 cP to about 750,000 cP.

11. The method of claim 8, wherein the diameter of the particles is between about 1 um to about 100 um.

12. The method of claim 1, further comprising;
flowing the slurry through the one or more apertures for up to about 54 minutes.

13. The method of claim 1, further comprising;
flowing the slurry through the one or more apertures for at least about 30 minutes.

14. The method of claim 1, wherein the gas distribution apparatus is a gas distribution plate having the one or more apertures formed therethrough and having a thickness between about 2 mm to about 20 mm.

15. The method of claim 1, wherein the gas distribution apparatus is a gas distribution plate having the one or more apertures formed therethrough and having a diameter of between about 350 mm to about 500 mm.
